(19) United States
(12) Patent Application Publication
(10) Pub. No.: US 2026/0180228 A1
(43) Pub. Date: Jun. 25, 2026

(54) CONNECTOR

(71) Applicant: SUMITOMO WIRING SYSTEMS, LTD., Mie (JP)

(72) Inventor: Ayaka NITO, Mie (JP)

(21) Appl. No.: 18/854,977

(22) PCT Filed: Apr. 5, 2023
(86) PCT No.: PCT/JP2023/014026

§ 371 Date: Oct. 8, 2024

(30) Foreign Application Priority Data
Apr. 14, 2022 (JP) 2022-067056

(51) Int. Cl. H01R 13/436; H01R 13/6581

(52) U.S. Cl. CPC H01R 13/436; H01R 13/6581

(57) ABSTRACT

A connector (10) includes a terminal member (11) and a terminal holding portion (20) for holding the terminal member (11). The connector (10) is provided with a protection wall (30) for surrounding the terminal member (11) and a shield portion (55) arranged along an outer peripheral surface of the protection wall (30). The protection wall (30) and the shield portion (55) are respectively arranged around the terminal member (11) except at parts in a forward direction (Z1). The shield portion (55) includes a bent portion (53, 54). The bent portion (53, 54) is bent toward an inner peripheral side of the protection wall (30) to be arranged along each of the outer peripheral surface of the protection wall (30) and an end surface of an end part in the end part in a circumferential direction of the protection wall (30).

### TECHNICAL FIELD

The present disclosure relates to a connector.

### BACKGROUND

Conventionally, a vehicle such as a hybrid or electric vehicle is provided with in-vehicle devices such as a high-voltage battery and an inverter. The in-vehicle devices are connected via a wiring harness and connectors. Such connectors generally include a protection wall for covering a terminal except a tip. In some connectors, the protection wall is partially cut to connect the terminal thereof and a terminal of a mating connector in an orthogonal state (see, for example, Patent Document 1).

Further, a connector described in Patent Document 1 includes a shield portion. The shield portion is made of an electrically conductive material (e.g. metal plate). The shield portion is provided to cover a surface of the protection wall on a side opposite to the terminal. By providing such a shield portion, noise intrusion is suppressed.

### PRIOR ART DOCUMENT

### Patent Document

Patent Document 1: JP 2019-185932 A

### SUMMARY OF THE INVENTION

### Problems to be Solved

Since the protection wall of the above connector has a partially cut structure, rigidity tends to be low. Such a protection wall has an easily deformable structure in the cut part. The above connector has a room for improvement in this respect.

Accordingly, it is aimed to provide a connector capable of suppressing the deformation of a protection wall.

### Means to Solve the Problem

The present disclosure is directed to a connector with a terminal member extending in a first direction, a terminal holding portion for holding the terminal member projecting in the first direction, a protection wall provided to project in the first direction from the terminal holding portion, the protection wall being arranged to surround the terminal member, and a shield portion arranged along an outer peripheral surface of the protection wall to cover the protection wall from an outer peripheral side, the protection wall and the shield portion being respectively arranged around the terminal member except at parts in a second direction orthogonal to the first direction, and the shield portion including a bent portion bent toward an inner peripheral surface of the protection wall to be arranged along each of the outer peripheral surface of the protection wall and an end surface of an end part in the end part in a circumferential direction of the protection wall.

### Effect of the Invention

According to the connector of the present disclosure, the deformation of the protection wall can be suppressed.

### BRIEF DESCRIPTION OF THE DRAWINGS

FIG. 1 is a perspective view of a connector of an embodiment.

FIG. 2 is a side view (side view along an arrow 2 in FIG. 1) of the connector of the embodiment.

FIG. 3 is a plan view (plan view along an arrow 3 in FIG. 1) of the connector of the embodiment.

FIG. 4 is an enlarged plan view of a protection wall and a shield portion in the connector of the embodiment.

FIG. 5 is a perspective view of a shield member in the connector of the embodiment.

FIG. 6 is a side view (side view along an arrow 6 in FIG. 3) of the connector of the embodiment.

### DETAILED DESCRIPTION TO EXECUTE THE INVENTION

### Description of Embodiments of Present Disclosure

First, embodiments of the present disclosure are listed and described.

(1) The connector of the present disclosure is provided with a terminal member extending in a first direction, a terminal holding portion for holding the terminal member projecting in the first direction, a protection wall provided to project in the first direction from the terminal holding portion, the protection wall being arranged to surround the terminal member, and a shield portion arranged along an outer peripheral surface of the protection wall to cover the protection wall from an outer peripheral side, the protection wall and the shield portion being respectively arranged around the terminal member except at parts in a second direction orthogonal to the first direction, and the shield portion including a bent portion bent toward an inner peripheral surface of the protection wall to be arranged along each of the outer peripheral surface of the protection wall and an end surface of an end part in the end part in a circumferential direction of the protection wall.

According to this configuration, by bending the end part in the circumferential direction of the shield portion toward the inner peripheral side, the rigidity of this end part, i.e. a part corresponding to the end part in the circumferential direction of the protection wall, can be enhanced. The deformation of the end part in the circumferential direction of the protection wall, i.e. a part easily becoming a starting point of deformation when the protection wall is deformed, can be suppressed by this shield portion. Therefore, even if the protection wall is pressed, the deformation of the protection wall associated with the pressing can be suppressed.

[2] Preferably, the terminal member is one of two terminal members, the two terminal members are arranged at an interval in a direction orthogonal to the first direction, the terminal holding portion is provided with a partition wall extending to partition between the two terminal members, and the partition wall extends from the inner peripheral surface of the protection wall to project to a position between both end parts in the circumferential direction of the protection wall and includes a projecting wall projecting in a thickness direction of the partition wall in an end part in a projecting direction.

According to this configuration, the rigidity of a projecting end part, which will become a starting point of deformation of the partition wall, can be enhanced by providing the projecting wall on the projecting end part. Thus, even if the partition wall is pressed, the deformation of the partition wall associated with the pressing can be suppressed.

[3] Preferably, the bent portion has an L-shaped cross-section and extends in the first direction.

According to this configuration, the deformation of the protection wall can be suitably suppressed.

[4] Preferably, an end part in the first direction of the protection wall is located further in the first direction than an end part in the first direction of the shield portion.

According to this configuration, the deformation of the protection wall can be suppressed, utilizing the shield portion of a small size to cover only a part of the outer peripheral surface of the protection wall while maintaining a function of protecting a necessary range around the terminal member by the protection wall.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. “Parallel” and “orthogonal” in this specification mean not only strictly parallel and orthogonal, but also substantially parallel and orthogonal within a range in which functions and effects in this embodiment are achieved. Note that the present invention is not limited to these illustrations, but is represented by claims and intended to include all changes in the scope of claims and in the meaning and scope of equivalents.

Further, out of XYZ axes orthogonal to each other in figures, the X axis represents a height direction X of a connector 10, the Y axis represents a width direction Y of the connector 10 and the Z axis represents a front-rear direction Z of the connector 10. Note that, in the following description, one height direction X is expressed as an “upward direction X1” and the other height direction X is expressed as a “downward direction X2”, one width direction Y is expressed as a “rightward direction Y1” and the other width direction Y is expressed as a “leftward direction Y2”, and one front-rear direction Z is expressed as a “forward direction Z1” and the other front-rear direction Z is expressed as a “rearward direction Z2”. The above expressions do not mean that the connector 10 is arranged in such a posture that the upward direction X1 is facing a top direction, and do not limit the arrangement posture of the connector 10.

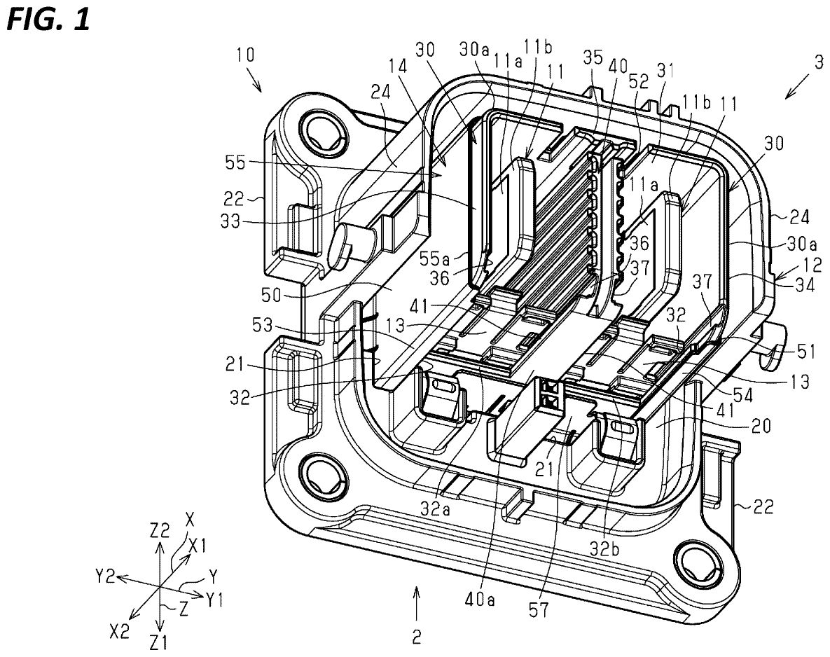

As shown in FIG. 1, the connector 10 is provided with two terminal members 11, one connector housing 12, two slide members 13 and one shield member 14.

### (Terminal Members 11)

As shown in FIGS. 1 to 3, a tip side of each terminal member 11 extends in the upward direction X1 serving as a first direction. Each terminal member 11 includes a terminal 11a and a protecting member 11b. The terminal 11a is plate-like. The terminal 11a is made of an electrically conductive metal plate material. The protecting member 11b is made of an insulating resin material. The protecting member 11b is fixed to a tip side of the terminal 11, i.e. an end part in the upward direction X1 of the terminal 11a (hereinafter, referred to as an upper end). The protecting member 11b is substantially U-shaped. A tip part of the terminal 11a and both end parts in the width direction of the terminal 11a are covered by the protecting member 11b. The two terminal members 11 are arranged at an interval in the width direction Y.

### (Connector Housing 12)

The connector housing 12 is made of an insulating resin material. The connector housing 12 includes a terminal holding portion 20, a protection wall 30 and a partition wall 40.

### (Terminal Holding Portion 20)

The terminal holding portion 20 holds a part in the downward direction X2 of each terminal member 11. In particular, each terminal member 11 is provided in the terminal holding portion 20 with the tip side of the terminal member 11 projecting in the upward direction X1 from the terminal holding portion 20. Parts of the respective terminal members 11 projecting in the upward direction X1 from the terminal holding portion 20 extend in the height direction X and the front-rear direction Z while extending in parallel to each other.

### (Protection Wall 30)

The protection wall 30 is shaped to project in the upward direction X1 from the terminal holding portion 20. The protection wall 30 is arranged around the two terminal members 11 except at a part in the forward direction Z1 around the protection wall 30. Note that, in this embodiment, the forward direction Z1 is equivalent to a second direction, which is a direction orthogonal to the first direction.

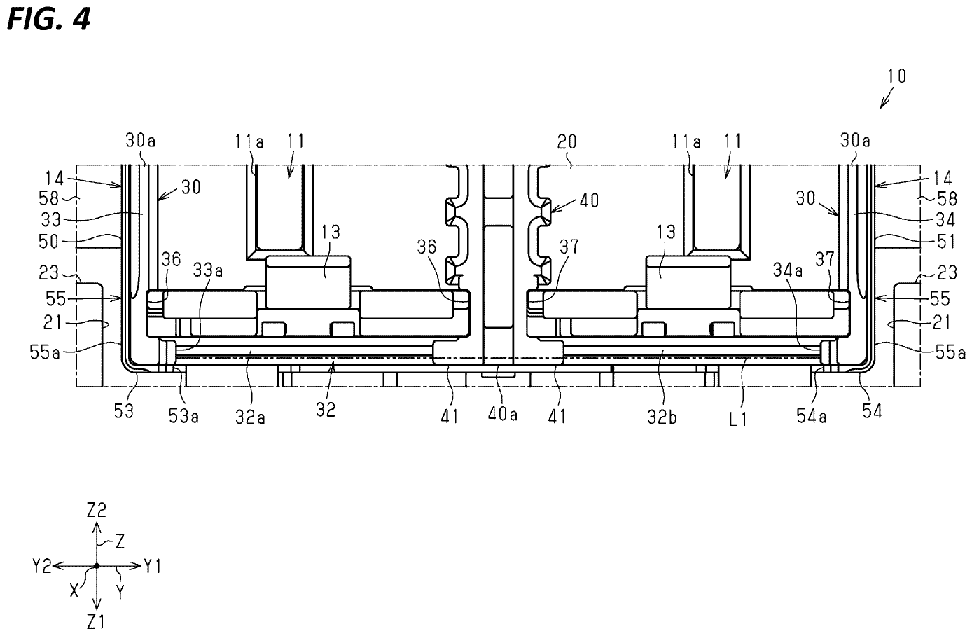

The protection wall 30 is, in particular, shaped such that, out of four walls constituting a rectangular tube extending in the height direction X, the entire wall on a side in the forward direction Z1 is cut off. By this configuration, the connector housing 12 includes a first opening 31 open in the upward direction X2 in the protection wall 30 and a second opening 32 open in the forward direction Z1 in the protection wall 31. The protection wall 30 includes a pair of side walls 33, 34 and a rear wall 35 linking end parts in the rearward direction Z2 of the pair of side walls 33, 34, the walls 33, 34 and 35 defining the second opening 32. The pair of side walls 33, 34 cover the two terminal members 11 arranged in the width direction Y from both sides while sandwiching those terminal members 11. In this embodiment, parts in the forward direction Z1 of the respective side walls 33, 34 are bent (for example, to have an L-shaped cross-section) to form corner parts, and end parts 33a, 34a of the two side walls 33, 34 located on the side in the forward direction Z1 are facing each other (see FIG. 4).

The terminal holding portion 20 is provided with an outer wall portion 24 arranged along the outer peripheral surface of the protection wall 30. The outer wall portion 24 is an outer wall of the connector 10, i.e. a wall forming the outer shape of the connector 10. The outer wall portion 20 is shaped to project in the upward direction X1 from the terminal holding portion 20. The outer wall portion 24 is provided at an interval from the protection wall 30. The outer wall portion 24 is arranged around the protection wall 30 except at a part in the forward direction Z1 around the protection wall 30. The outer wall portion 24 is, in particular, shaped such that, out of four walls constituting a rectangular tube extending in the height direction X, the entire wall on the side in the forward direction Z1 is cut off.

### (Partition Wall 40)

The partition wall 40 extends to partition between the two terminal members 11. The partition wall 40 is shaped to project in the upward direction X1 from the terminal holding portion 20. The partition wall 40 is provided at a middle position in the width direction Y in a part between the pair of side walls 33, 34 and at a middle position in the width direction Y in a part between the two terminal members 11. The partition wall 40 extends in the height direction X and the front-rear direction Z. The partition wall 40 and the two terminal members 11 extend in parallel. An end part in the rearward direction Z2 of the partition wall 40 is integrally configured to the rear wall 35 of the protection wall 30. As shown in FIG. 4, a front end part 40a in the forward direction Z1 of the partition wall 40 extends to a middle position of a line segment L1 connecting the end parts 33a, 34a in the forward direction Z1 of the pair of side walls 33, 34. In this way, the partition wall 40 projects from the inner peripheral surface of the protection wall 30 to the middle position between the both end parts 33a, 34a in a circumferential direction of the protection wall 30.

### (Projecting Walls 41)

As shown in FIGS. 1 and 4, projecting walls 41 projecting in the width direction Y, which is a thickness direction of the partition wall 40, are provided on the front end part 40a of the partition wall 40. The projecting walls 41 are provided on both ends in the width direction Y of the front end part 40a of the partition wall 40. Each projecting wall 41 extends over the entire front end part 40a of the partition wall 40 in the height direction X.

### (Slide Members 13)

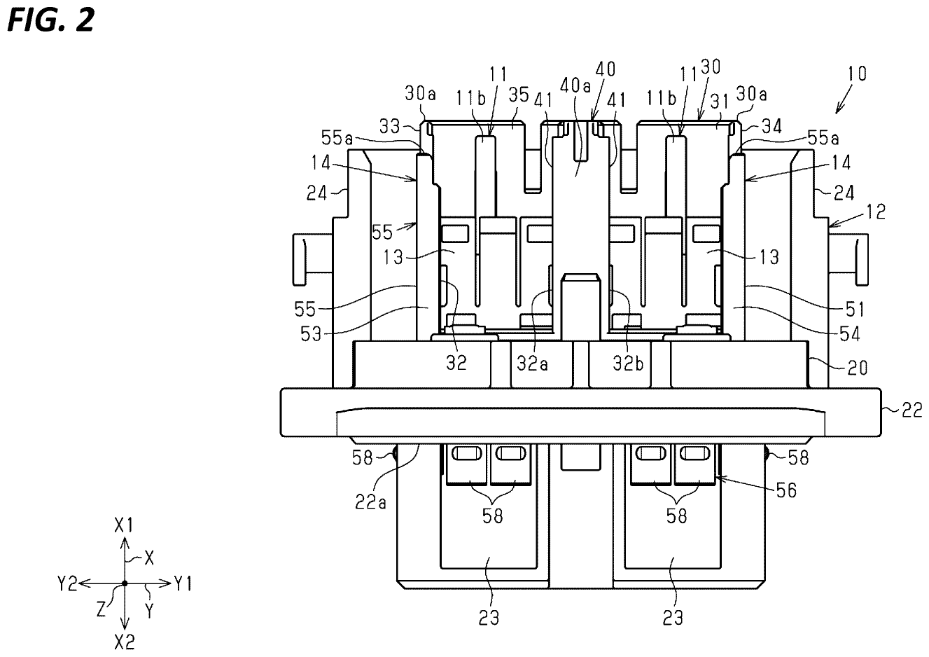

As shown in FIGS. 1 to 3, the second opening 32 is divided into a divided opening 32a corresponding to one terminal member 11 and a divided opening 32b corresponding to the other terminal member 11 by the partition wall 40. One slide member 13 is provided for each of the divided openings 32a, 32b. The slide member 13 is plate-like. The slide member 13 is made of an insulating resin material. The slide member 13 is slidable between a closing position (position shown in FIG. 2) for closing the divided opening 32a, 32b and an opening position for opening the divided opening 32a, 32b. Note that the closing position for closing the divided opening 32a, 32b may be a position where the divided opening 32a, 32b can be closed to such an extend that a finger does not reach the terminal member 11 through the divided opening 32a, 32b. Therefore, the slide member 13 does not necessarily close the entire divided opening 32a, 32b also at the closing position.

As shown in FIGS. 1 and 4, both side walls constituting the divided opening 32a, i.e. the side wall 33 and the partition wall 40, are provided with a pair of guide grooves 36 extending in end parts on the side of the divided opening 32a while facing each other. The guide grooves 36 extend in the height direction X while being parallel to each other. Both end parts in the width direction Y of the slide member 13 are fit in the pair of guide grooves 36. The slide member 13 is configured to be slidable in the height direction X by being guided by the pair of guide grooves 36.

Further, both side walls constituting the divided opening 32b, i.e. the side wall 34 and the partition wall 40, are provided with a pair of guide grooves 37 extending in end parts on the side of the divided opening 32b while facing each other. The guide grooves 37 extend in the height direction X while being parallel to each other. Both end parts in the width direction of the slide member 13 are fit in the pair of guide grooves 37. The slide member 13 is configured to be slidable in the height direction X by being guided by the pair of guide grooves 37.

Each slide member 13 is at the closing position in a state where a mating connector (not shown) is not connected to the connector 10. Each slide member 13 slides in the downward direction X2 from the closing position to the opening position by being pressed by the mating connector when the mating connector (not shown) is connected to the connector 10. Further, each slide member 13 slides in the upward direction X1 from the opening position to the closing position by being pulled by the mating connector when the mating connector is separated from the connector 10.

### (Shield Member 14)

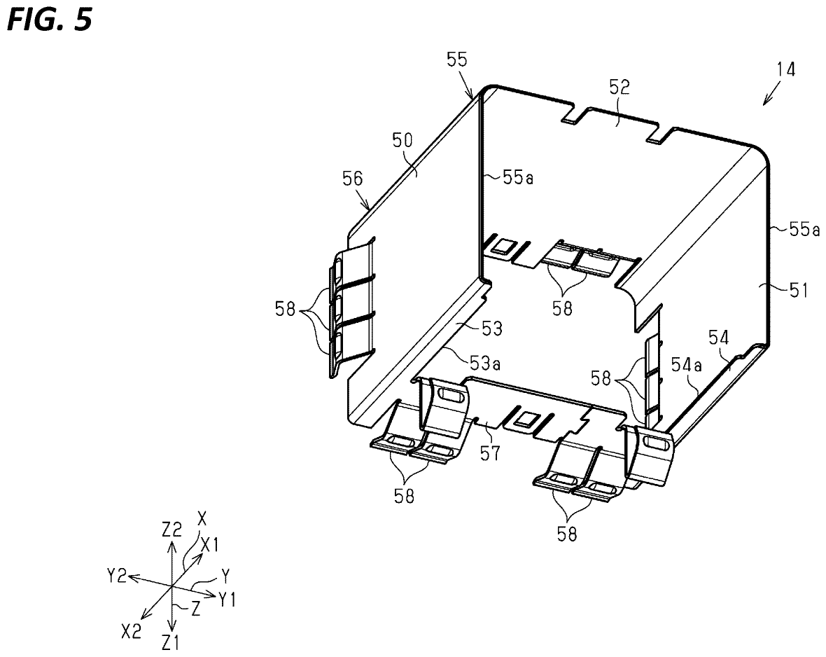

As shown in FIGS. 1 and 5, the shield member 14 is made of an electrically conductive material (e.g. metal plate). The shield member 14 includes a pair of side wall portions 50, 51 and a rear wall portion 52. The pair of side wall portions 50, 51 extend in parallel while being spaced apart in the width direction Y. Each side wall portion 50, 51 extends in the height direction X and the front-rear direction Z. The rear wall portion 52 is shaped to link end parts in the rearward direction Z2 of the pair of side wall portions 50, 51. The rear wall portion 52 extends in the height direction X and the width direction Y.

A bent portion 53 is provided on an end part in the forward direction Z1 (hereinafter, referred to as a front side) of the side wall portion 50. A bent portion 54 is provided on the front end of the side wall portion 51. Each bent portion 53, 54 is shaped by bending the front end of the side wall portion 50, 51 at a right angle toward an inner peripheral side of the shield member 14. That is, a part in the rearward direction Z2 of each bent portion 53, 54 extends in the height direction X and the front-rear direction Z and a part in the forward direction Z1 extends in the height direction X and the width direction Y. Each bent portion 53, 54 extends in the height direction X while having an L-shaped cross-section. Each bent portion 53, 54 extends over the entire front end of the side wall portion 50, 51 in the height direction X.

### (Shield Portion 55)

A part in the upward direction X1 of the shield member 14 constitutes a shield portion 55. The shield portion 55 is arranged along the outer peripheral surface of the protection wall 30 to cover the protection wall 30 from an outer peripheral side. The shield portion 55 is arranged around the two terminal members 11 except at a part in the forward direction Z1 around the shield portion 55. As shown in FIGS. 1 and 4, each bent portion 53, 54 is bent toward an inner peripheral side of the protection wall 30 to be arranged along each of the outer peripheral surface and the end surface in the forward direction Z1 of the side wall 33, 34 at the front end of the side wall 33, 34. In other words, in this embodiment, the parts in the forward direction Z1 of the respective side wall portions 50, 51 of the shield portion 55 (shield member 14) are bent (e.g. to have an L-shaped cross-section) to form the corner parts, and the corner parts of those side wall portions 50, 51 are provided as the bent portions 53, 54. End parts 53a, 54a of these two bent portions 53, 54 on the inner peripheral side are facing each other (see FIG. 4).

In this embodiment, the end part 53a on the inner peripheral side of the bent portion 53 of the shield member 14 is located further on the outer peripheral side than the end part 33a of the side wall 33 of the protection wall 30. In other words, the end part 33a is located closer to a central side in the width direction Y than the end part 53a. Further, the end part 54a on the inner peripheral side of the bent portion 54 of the shield member 14 is located further on the outer peripheral side than the end part 34a of the side wall 34 of the protection wall 30. In other words, the end part 34a is located closer to the central side in the width direction Y than the end part 54a.

As shown in FIGS. 1 and 2, in this embodiment, an end part 30a in the upward direction X1 of the protection wall 30 is located further in the upward direction X1 than the end part 55a in the upward direction X1 of the shield portion 55. That is, the protection wall 30 extends to a position further in the upward direction X1 than the shield portion 55.

As shown in FIG. 5, a part in the downward direction X2 of the shield member 14 constitutes a fixing portion 56. A front wall portion 57 linking the bent portions 53, 54 of the respective side wall portions 50, 51 is provided on the part in the downward direction X2 of the shield member 14. The front wall portion 57 extends in the height direction X and the width direction Y. The fixing portion 56 is formed into a rectangular tube shape by the pair of side wall portions 50, 51, the rear wall portion 52 and the front wall portion 57.

The fixing portion 56 includes a plurality of lock portions 58. In particular, each of the side wall portions 50, 51 is provided with three lock portions 58. Further, each of the front wall portion 57 and the rear wall portion 52 is provided with four lock portions 58. Each lock portion 58 is in the form of a plate extending in the height direction X. The upper end of each lock portion 58 is integrated with the peripheral wall of the shield member 14. Each lock portion 58 has a convex shape projecting toward the outer peripheral side of the shield member 14 and is bent in a middle part in the height direction X to have a V-shaped cross-section. Each lock portion 58 is configured to be resiliently deformable toward the inner peripheral side of the shield member 14 with an upper end as a fulcrum.

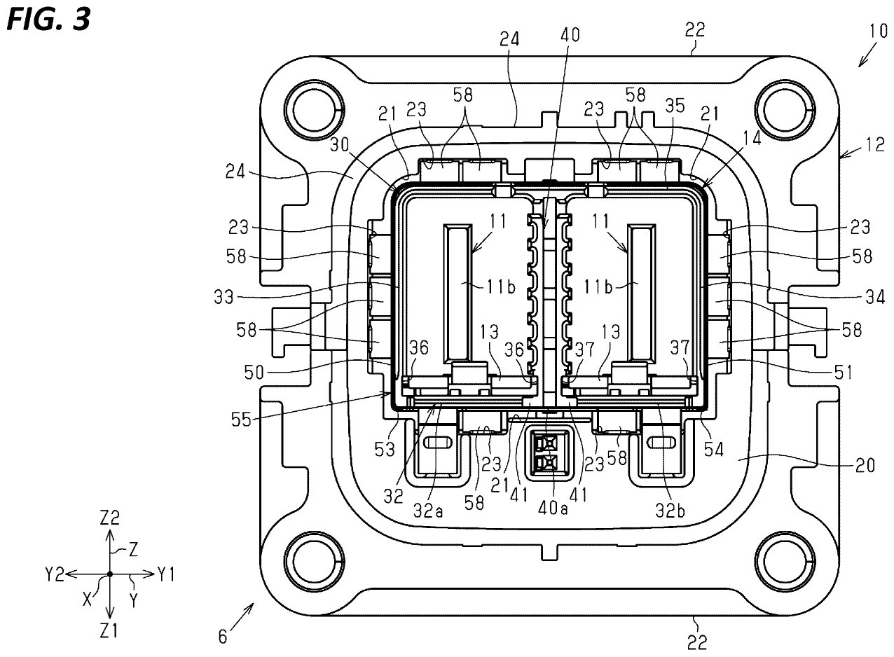

As shown in FIGS. 1 and 3, the terminal holding portion 20 includes a fixing groove 21 open in a surface in the upward direction X1. The fixing groove 21 extends while having a rectangular ring shape to surround the protection wall 30. A surface of the fixing groove 21 on the inner peripheral side is shaped by extending the outer peripheral surface of the protection wall 30 in the downward direction X2. The fixing portion 56 of the shield member 14 is fit in the fixing groove 21. In this way, the shield member 14 is held on the terminal holding portion 20.

As shown in FIGS. 1 and 2, a flange portion 22 is provided to project on the outer surface of the terminal holding portion 20. The flange portion 22 is provided in a middle part in the height direction X of the terminal holding portion 20. The flange portion 22 extends around the terminal holding portion 20 while having an annular shape.

As shown in FIGS. 2 and 3, the terminal holding portion 20 includes a plurality of through portions 23. Each through portion 23 allows communication between the inside of the fixing groove 21 and the outside of the terminal holding portion 20 in such a manner that the fixing groove 21 is open to the outer peripheral side. One through portion 23 is provided in each of parts of the fixing groove 21 where one and the other of the side wall portions 50, 51 of the shield member 14 are fit. Further, two through portions 23 are provided in each of parts of the fixing groove 21 where the front wall portion 57 and the rear wall portion 52 of the shield member 14 are fit. In the terminal holding portion 20 of this embodiment, the upper end of each through portion 23 is located at the same position as a surface in the downward direction X2 of the flange portion 22 (hereinafter, lower surface 22a) in the height direction X.

In this embodiment, in mounting the shield member 14 on the terminal holding portion 20, the lock portions 58 of the shield member 14 are fit into the respective through portions 23 of the terminal holding portion 20.

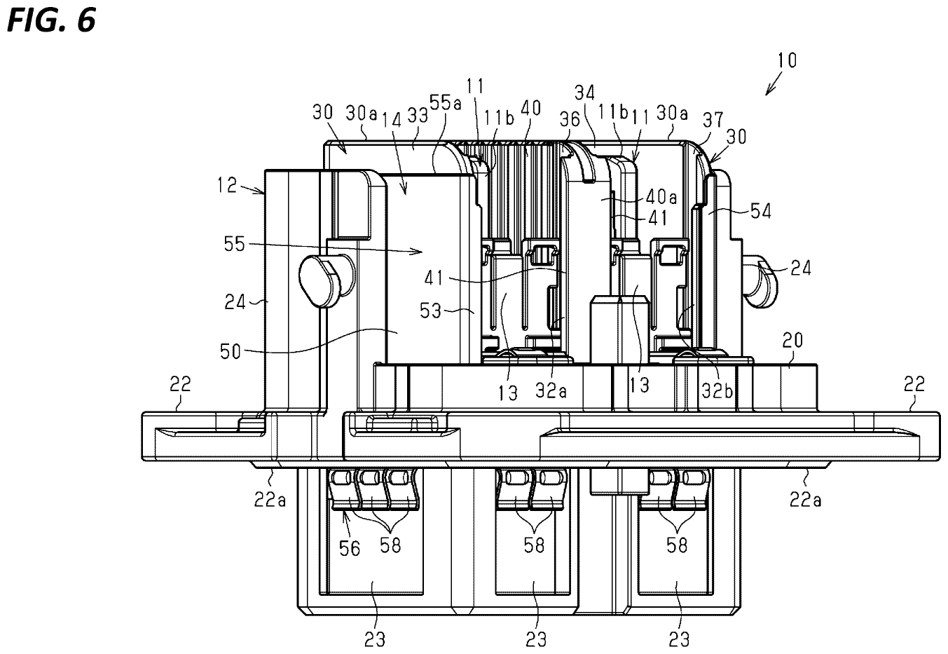

Specifically, the fixing portion 56 of the shield member 14 is first inserted into the fixing groove 21 of the terminal holding portion 20. At this time, each lock portion 58 of the fixing portion 56 is pressed by the inner surface of the fixing groove 21 and resiliently deformed toward the inner peripheral side of the shield member 14. If the shield member 14 moves in the downward direction X2 and each lock portion 58 reaches the through portion 23 of the terminal holding portion 20 in that state, each lock portion 58 is released from pressure from the inner surface of the fixing groove 21. In this way, each lock portion 58 is resiliently deformed toward the outer peripheral side of the shield member 14 and returns to an initial shape. As a result, as shown in FIGS. 2 and 6, the middle part in the height direction X of each lock portion 58, i.e. the convex part projecting toward the outer peripheral side of the shield member 14, is hooked to the lower surface 22a of the flange portion 22. By engaging each lock portion 58 of the fixing portion 56 with the lower surface 22a of the flange portion 22 in this way, the shield member 14 is held on and fixed to the terminal holding portion 20.

### (Effects)

Effects of this embodiment are described.

(1) The connector 10 is provided with the terminal members 11, the terminal holding portion 20, the protection wall 30 and the shield portion 55. The tip side of the terminal member 11 extends in the upward direction X1. The terminal holding portion 20 holds the terminal member 11 projecting in the upward direction X1. The protection wall 30 is provided on the terminal holding portion 20 to project in the upward direction X1 and arranged to surround the terminal members 11. The shield portion 55 is arranged along the outer peripheral surface of the protection wall 30 to cover the protection wall 30 from the outer peripheral side. The protection wall 30 and the shield portion 55 are respectively arranged around the terminal members 11 except at the parts in the forward direction Z1. The shield portion 55 includes the bent portions 53, 54. The bent portion 53, 54 has the shape bent toward the inner peripheral side of the protection wall 30 to be arranged along each of the end surface of the end part 33a, 34a and the outer peripheral surface of the protection wall 30. According to this configuration, by bending the end parts in the circumferential direction of the shield member 55 toward the inner peripheral side, the end parts of the shield portion 55, i.e. the parts corresponding to the end parts 33a, 34a in the circumferential direction of the protection wall 30 can be enhanced in rigidity. The deformation of the end parts 33a, 34a in the circumferential direction of the protection wall 30, i.e. the parts tending to be starting points of deformation when the protection wall 30 is deformed, can be suppressed by this shield portion 55. Therefore, even if the protection wall 30 is pressed, the deformation of the protection wall 30 associated with the pressing can be suppressed.

(2) The terminal holding portion 20 is provided with the partition wall 40 extending to partition between the two terminal members 11. The partition wall 40 projects from the inner peripheral surface of the protection wall 30 to the position between the both end parts 33a, 34a in the circumferential direction of the protection wall 30. The partition wall 40 includes the projecting walls 41 projecting in the thickness direction of the partition wall 40 at the front end part 40a. According to this configuration, the rigidity of a projecting end part, which will become a starting point of deformation of the partition wall 40, can be enhanced by providing the projecting walls 41 on that projecting end part. Thus, even if the partition wall 40 is pressed, the deformation of the partition wall 40 associated with the pressing can be suppressed.

(3) Each bent portion 53, 54 extends in the height direction X while having an L-shaped cross-section. According to this configuration, the rigidity of the end parts of the shield portion 55 can be suitably enhanced. In this way, the deformation of the protection wall 30 can be suitably suppressed.

(4) The end part 30a in the upward direction X1 of the protection wall 30 is located further in the upward direction X1 than the end part 55a in the upward direction X1 of the shield portion 55. According to this configuration, the deformation of the protection wall 30 can be suppressed, utilizing the shield portion 55 of a small size to cover only a part of the outer peripheral surface of the protection wall 30 while maintaining a function of protecting a necessary range around the terminal member 11 by the protection wall 30.

### (Modifications)

This embodiment can be modified and carried out as follows. This embodiment and the following modifications can be carried out in combination without technically contradicting each other.
The shape of the projecting wall 41 can be changed as appropriate, for example, by cutting a part in the height direction X.
In the connector 10 of the above embodiment, the projecting walls 41 are provided on the both ends in the width direction Y of the front end part 40a of the partition wall 40. However, besides this, the projecting wall 41 may be, for example, provided only on one of the both ends in the width direction Y of the front end part 40a of the partition wall 40.
The projecting walls 41 may be omitted from the connector 10 of the above embodiment.
The shape of the bent portion 53, 54 is not limited to the one extending while having an L-shaped cross-section, but can be changed as appropriate, for example, a shape extending while having a J-shaped cross-section or a shape extending while having a U-shaped cross-section. The bent portion 53, 54 can be, for example, shaped by cutting a part in the height direction X.
The bent portion 53 and the side wall 33 may be configured such that an end surface on the inner peripheral side of the end part 53a of the bent portion 53 is flush with an end surface on the inner peripheral side of the end part 33a of the side wall 33. Further, the bent portion 54 and the side wall 34 may be configured such that an end surface on the inner peripheral side of the end part 54a of the bent portion 54 is flush with an end surface on the inner peripheral side of the end part 34a of the side wall 34. Here, if the end parts 53a, 54a of the bent portions 53, 54 project further toward the inner peripheral side than the end parts 33a, 34a of the side walls 33, 34, it becomes difficult to keep insulation distances between the shield member 14 and the terminal members 11. On the other hand, if the end parts 53a, 54a of the bent portions 53, 54 are retracted further toward the outer peripheral side than the end parts 33a, 34a of the side walls 33, 34, extended areas of the bent portions 53, 54 become smaller by that much, wherefore the effect of enhancing the rigidity of the bent portions 53, 54 is reduced. In the configuration of this modification, the end surfaces on the inner peripheral side of the end parts 53a, 54a of the bent portions 53, 54 are flush with the end surfaces on the inner peripheral side of the end parts 33a, 34a of the side walls 33, 34. Thus, the rigidity of the bent portions 53, 54 can be enhanced while the insulation distances between the shield member 14 and the terminal members 11 are kept.
The protection wall 30 and the shield portion 55 may be configured such that the end part 30a of the protection wall 30 and the end part 55a of the shield portion 55 are located at the same position in the upward direction X1. The protection wall 30 and the shield portion 55 may also be configured such that the end part 55a of the shield portion 55 is located further in the upward direction X1 than the end part 30a of the protection wall 30.
The structure of the fixing portion 56 of the shield member 14 can be changed as appropriate. For example, the fixing portion 56 may be configured into a rectangular tube shape not including the lock portions 58. In this case, the fixing groove 21 of the terminal holding portion 20 may be, for example, configured such that the fixing portion 56 can be press-fit thereinto. In this configuration, the shield member 14 is held on the terminal holding portion 20 by press-fitting the fixing portion 56 of the shield member 14 into the fixing groove 21 of the terminal holding portion 20.
The front wall portion 57 may be omitted from the shield member 14 of the above embodiment.
The fixing portion 56 may be omitted from the shield member 14 of the above embodiment. In this case, the shield member 14 and the protection wall 30 may be configured such that the shield member 14 is mountable on the protection wall 30, for example, by a snap-fit structure.
One protection wall 30 and one shield portion 55 are provided for the two terminal members 11 in the connector 10 of the above embodiment. However, besides this, one protection wall 30 and one shield portion 55 may be, for example, provided for one terminal member 11. In this configuration, the partition wall 40 can be omitted.
The number of the terminal members 11, the number of the protection wall 30 and the number of the shield portion 55 provided in the connector 10 are not limited to those of the above embodiment, but can be changed as appropriate according to the specifications of the required connector 10.
The present disclosure encompasses the following embodiments. Note that the reference signs denoting the constituent elements of the above embodiment are given not for limitation, but merely for assisting understanding.

### (Addendum 1)

A connector (10) is provided with: a terminal member (11); a terminal holding portion (20) for holding the terminal member (11); a protection wall (30) for surrounding the terminal member (11), the protection wall (30) including two side walls (33, 34) and a rear wall (35) linking the two side walls (33, 34); and a shield portion (55) arranged along an outer peripheral surface of the protection wall (30), the shield portion (55) including two side wall portions (50, 51) and a rear wall portion (52) linking the two side wall portions (50, 51), parts on a front side of the two side walls (33, 34) of the protection wall (30) being respectively bent to form corner parts, and parts on the front side of the two side wall portions (50, 51) of the shield portion (55) being respectively bent to form corner parts (53, 54).

### (Addendum 2)

In the connector of Addendum 1, the corner parts of the two side walls (33, 34) of the protection wall (30) are bent to have an L-shaped cross-section, and the corner parts (53, 54) of the two side wall portions (50, 51) of the shield portion (55) are bent to have an L-shaped cross-section.

### LIST OF REFERENCE NUMERALS

10 connector
11 terminal member
11a terminal
11b protecting member
12 connector housing
13 slide member
14 shield member
20 terminal holding portion
21 fixing groove
22 flange portion
22a lower surface
23 through portion
24 outer wall portion
30 protection wall
30a end part
31 first opening
32 second opening
32a divided opening
32b divided opening
33 side wall
33a end part
34 side wall
34a end part
35 rear wall
36 guide groove
37 guide groove
40 partition wall
40a front end part
41 projecting wall
50 side wall portion
51 side wall portion
52 rear wall portion
53 bent portion
53a end part
54 bent portion
54a end part
55 shield portion
55a end part
56 fixing portion
57 front wall portion
58 lock portion

1. A connector, comprising:
a terminal member extending in a first direction;
a terminal holding portion for holding the terminal member projecting in the first direction;
a protection wall provided to project in the first direction from the terminal holding portion, the protection wall being arranged to surround the terminal member; and
a shield portion arranged along an outer peripheral surface of the protection wall to cover the protection wall from an outer peripheral side,
the protection wall and the shield portion being respectively arranged around the terminal member except at parts in a second direction orthogonal to the first direction, and
the shield portion including a bent portion bent toward an inner peripheral surface of the protection wall to be arranged along each of the outer peripheral surface of the protection wall and an end surface of an end part in the end part in a circumferential direction of the protection wall.

2. The connector of claim 1, wherein:
the terminal member is one of two terminal members,
the two terminal members are arranged at an interval in a direction orthogonal to the first direction,
the terminal holding portion is provided with a partition wall extending to partition between the two terminal members, and
the partition wall extends from the inner peripheral surface of the protection wall to project to a position between both end parts in the circumferential direction of the protection wall and includes a projecting wall projecting in a thickness direction of the partition wall in an end part in a projecting direction.

3. The connector of claim 1, wherein the bent portion has an L-shaped cross-section and extends in the first direction.

4. The connector of claim 1, wherein an end part in the first direction of the protection wall is located further in the first direction than an end part in the first direction of the shield portion.
